(19) United States
(12) Patent Application Publication
(10) Pub. No.: US 2010/0110110 A1
(43) Pub. Date: May 6, 2010

(54) DRIVING CIRCUIT

(76) Inventors: Po-Chang Wu, Taichung County (TW); Wen-Chi Wu, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 12/471,412

(22) Filed: May 25, 2009

(30) Foreign Application Priority Data
Oct. 30, 2008 (TW) 097141738

(51) Int. Cl. G09G 5/10; G09G 3/36

(52) U.S. Cl. 345/690; 345/89

(57) ABSTRACT

The present invention provides a driving circuit. The driving circuit comprises: a plurality of signal output terminals, a data signal generating module, a gray level reference voltage generating module, a digital-to-analog converter (DAC), a first multiplex output module, an output buffer, a second multiplex output module, and a switch module. The driving circuit of the present invention can reduce the amount of required output buffers, so as to reduce area of the driving circuit efficiently and lower the production cost.

### BACKGROUND OF THE INVENTION

1. Field of the Invention

The present invention relates to a driving circuit, and more particularly, to a source driver applied to an LCD panel, the driving circuit is capable of reducing the amount of required output buffers, so as to reduce area of the driving circuit efficiently and lower the production cost.

2. Description of the Prior Art

FIG. 1 shows a simplified block diagram of a source driver 100 applied to an LCD panel in accordance with a prior art. As shown in FIG. 1, the source driver 100 comprises: a plurality of signal output terminals S1˜Sn, a data signal generating module 110, a gray level reference voltage generating module 120, a digital-to-analog converter (DAC) 130, and an output buffer and switch module 140. The data signal generating module 110 is utilized for generating a plurality of digital data signals D1˜Dn, and the gray level reference voltage generating module 120 is utilized for generating a plurality of gray level reference voltages. The DAC 130 is coupled to the data signal generating module 110 and the gray level reference voltage generating module 120, and is utilized for generating a plurality of voltage signals A1˜An corresponding to the plurality of digital data signals D1˜Dn in accordance with the plurality of gray level reference voltages, respectively. The DAC 130 comprises a plurality of analog output terminals (not shown), respectively for outputting the plurality of voltage signals A1˜An. The data signal generating module 110 further comprises: a shift register, a line latch, and a level shifter. The data signal generating module 110 is well known to those of average skill in this art, and thus further explanation of the details and operations about the data signal generating module 110 are omitted herein for the sake of brevity.

FIG. 2 shows a simplified block diagram of the output buffer and switch module 140 in FIG. 1. As shown in FIG. 2, the output buffer and switch module 140 comprises: a plurality of switch elements SWg1˜SWgn, a plurality of switch elements SWp1˜SWpn, and a plurality of output buffers B1˜Bn. The plurality of switch elements SWg1˜SWgn and the plurality of switch elements SWp1˜SWpn are respectively coupled between the plurality of voltage signals A1˜An of the DAC 130 and the plurality of signal output terminals S1˜Sn. The output buffers B1˜Bn are respectively coupled between the plurality of voltage signals A1˜An of the DAC 130 and the plurality of switch elements SWp1˜SWpn. In addition, the plurality of switch elements SWg1˜SWgn are controlled by switch control signals GM_EN, respectively. The plurality of switch elements SWp1˜SWpn are controlled by switch control signals PM_EN, respectively.

Next, please refer to FIG. 3. FIG. 3 shows a timing diagram of the switch control signals PB_EN and the switch control signal GM_EN and a voltage level variation diagram of the plurality of signal output terminals S1˜Sn during the two time periods T1˜T2. The plurality of switch elements SWg1˜SWgn and the plurality of switch elements SWp1˜SWpn all are N-type FETs (such as NMOSFETs), and thus, as shown in FIG. 3, during the time period T1, the switch control signal PB_EN1 is in a high logic level to conduct the plurality of switch elements SWp1˜SWpn, and the switch control signal GM_EN is in a low logic level to not conduct the switch elements SWg1˜SWgn. In this way, the plurality of voltage signals A1˜An can pull up the voltage level of the plurality of signal output terminals S1˜Sn from VGSx1˜VGSxn to near VGSy1˜VGSyn via the plurality of output buffers B1˜Bn, respectively. Next, during the time period T2, the switch control signal PB_EN1 becomes to be in the low logic level to not conduct the plurality of switch elements SWp1˜SWpn, and the switch control signal GM_EN becomes to be in the high logic level to conduct the plurality of switch elements SWg1˜SWgn. In this way, the voltage levels of the signal output terminals S1˜Sn can be directly calibrated by the plurality of voltage signals A1˜An (i.e. gray level reference voltage) to be VGSy1˜VGSyn, respectively.

However, since each signal output terminal of the plurality of signal output terminals S1˜Sn requires an output buffer in this prior art, it results in a over large amount of the required output buffers, and let the source driver 100 has a over large area, and it is not able to reduce the production cost of the source driver 100.

### SUMMARY OF THE INVENTION

It is therefore one of the objectives of the present invention to provide a driving circuit capable of reducing the amount of required output buffers to reduce area of the driving circuit efficiently and lower the production cost, so as to solve the above problem.

In accordance with an embodiment of the present invention, a driving circuit is disclosed. The driving circuit comprises: a plurality of signal output terminals, a data signal generating module, a gray level reference voltage generating module, a digital-to-analog converter (DAC), a first multiplex output module, an output buffer, a second multiplex output module, and a switch module. The data signal generating module is utilized for generating a plurality of digital data signals. The gray level reference voltage generating module is utilized for generating a plurality of gray level reference voltages. The DAC is coupled to the data signal generating module and the gray level reference voltage generating module, and is utilized for generating a plurality of voltage signals corresponding to the plurality of digital data signals in accordance with the plurality of gray level reference voltages, respectively. The first multiplex output module has a first output terminal and a plurality of first input terminals, wherein the plurality of first input terminals respectively receive the plurality of voltage signals, and the first multiplex output module selects a first specific voltage signal from the plurality of voltage signals during a first time period and outputs the first specific voltage signal via the first output terminal. The output buffer is coupled to the first output terminal, and is utilized for generating a first specific driving signal in accordance with the first specific voltage signal. The second multiplex output module has a plurality of second output terminals and a second input terminal, wherein the plurality of second output terminals are respectively coupled to the plurality of signal output terminals, the second input terminal receives the first specific driving signal, and the second multiplex output module outputs the first specific driving signal via a first specific output terminal from the plurality of second output terminals to a first specific signal output terminal. The switch module is coupled between the DAC and the plurality of signal output terminals, and is utilized for outputting the first specific voltage signal to the first specific signal output terminal during a second time period different from the first time period.

Briefly summarized, the driving circuit disclosed by the present invention is capable of reducing the amount of required output buffers, so as to reduce area of the driving circuit efficiently and lower the production cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a source driver applied to an LCD panel in accordance with a prior art.

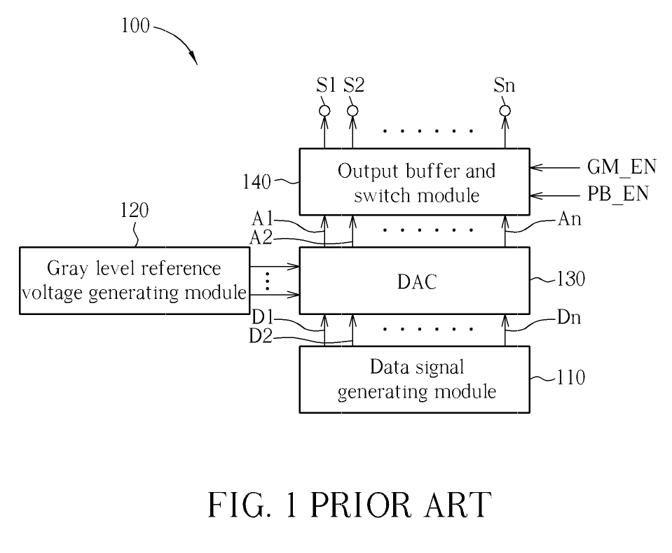

FIG. 2 shows a simplified block diagram of the output buffer and switch module in FIG. 1.

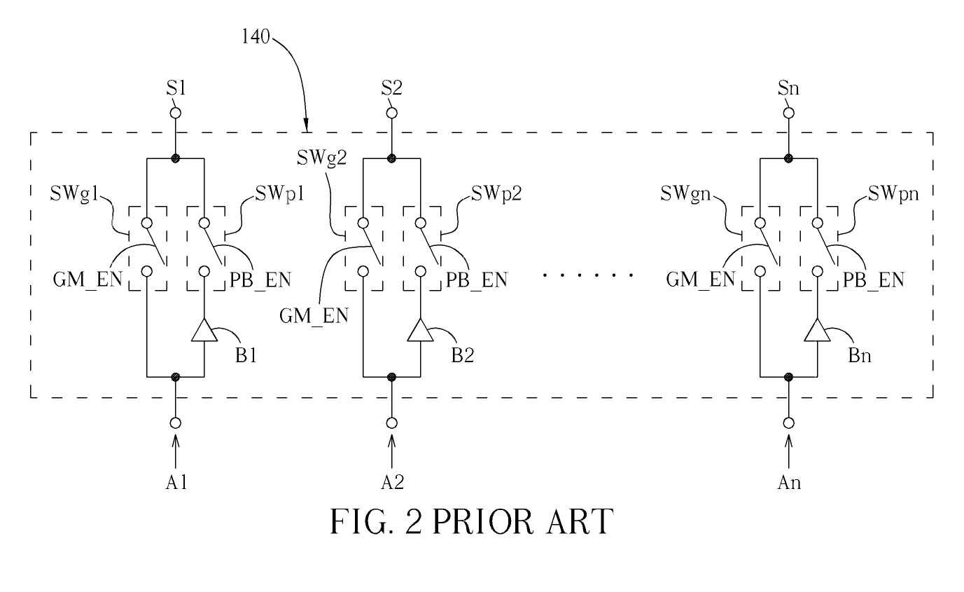

FIG. 3 shows a timing diagram of the switch control signals PB_EN and the switch control signal GM_EN and a voltage level variation diagram of the plurality of signal output terminals S1˜Sn during the two time periods T1˜T2.

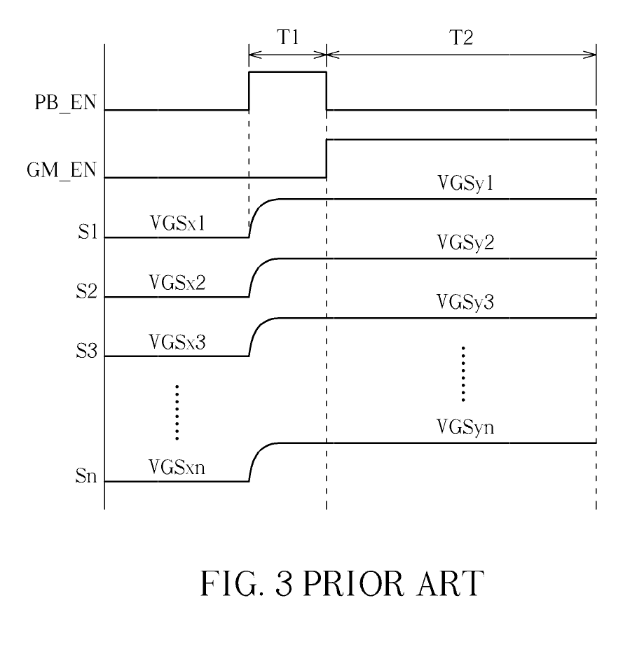

FIG. 4 shows a simplified block diagram of a source driver applied to an LCD panel in accordance with an embodiment of the present invention.

FIG. 5 shows a simplified block diagram of the first multiplex output module in FIG. 4.

FIG. 6 shows a simplified block diagram of the second multiplex output module in FIG. 4.

FIG. 7 shows a simplified block diagram of the switch module in FIG. 4.

FIG. 8 shows a timing diagram of three switch control signals PB_EN1˜PB_EN3 and three switch control signals GM_EN1˜GM_EN3 and a voltage level variation diagram of three signal output terminals S1˜S3 during the four time periods T1˜T4.

FIG. 9 shows a simplified block diagram of the source driver 400 during the time period T1.

FIG. 10 shows a simplified block diagram of the source driver 400 during the time period T2.

FIG. 11 shows a simplified block diagram of the source driver 400 during the time period T3.

FIG. 12 shows a simplified block diagram of the source driver 400 during the time period T4.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

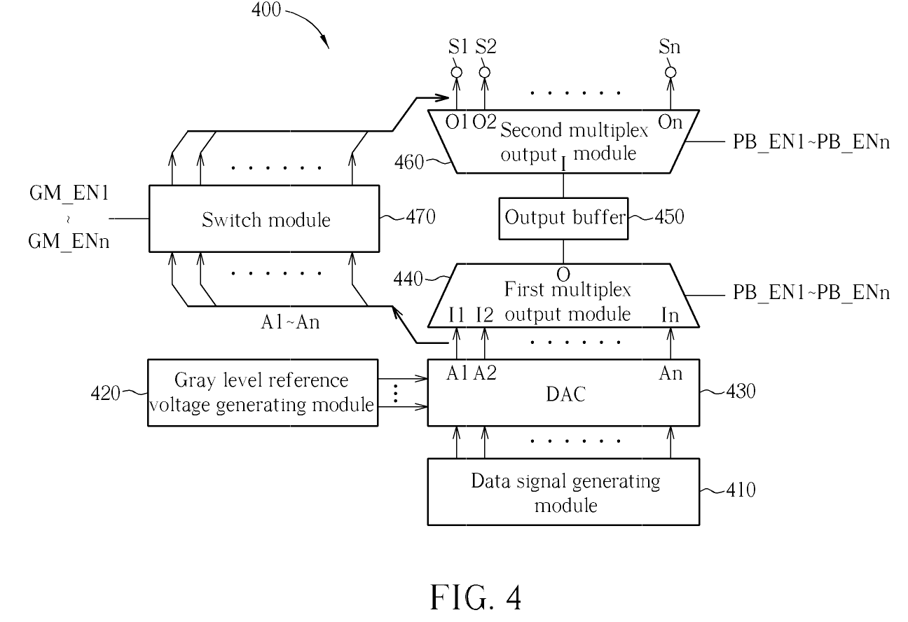

Please refer to FIG. 4. FIG. 4 shows a simplified block diagram of a source driver 400 applied to an LCD panel in accordance with an embodiment of the present invention. As shown in FIG. 4, the source driver 400 comprises: a plurality of signal output terminals S1˜Sn, a data signal generating module 410, a gray level reference voltage generating module 420, a digital-to-analog converter (DAC) 430, a first multiplex output module 440, an output buffer 450, a second multiplex output module 460, and a switch module 470. The data signal generating module 410 is utilized for generating a plurality of digital data signals D1˜Dn, and the gray level reference voltage generating module 420 is utilized for generating a plurality of gray level reference voltages. The DAC 430 is coupled to the data signal generating module 410 and the gray level reference voltage generating module 420, and is utilized for generating a plurality of voltage signals A1˜An corresponding to the plurality of digital data signals D1˜Dn in accordance with the plurality of gray level reference voltages, respectively. The DAC 430 comprises a plurality of analog output terminals (not shown), respectively for outputting the plurality of voltage signals A1˜An.

The first multiplex output module 440 has a first output terminal O and a plurality of first input terminals I1˜In, wherein the plurality of first input terminals I1˜In respectively receive the plurality of voltage signals A1˜An, and the first multiplex output module 440 selects a first specific voltage signal (such as A1) from the plurality of voltage signals A1˜An during a first time period and outputs the first specific voltage signal via the first output terminal. The output buffer 450 is coupled to the first output terminal O, and is utilized for generating a first specific driving signal (not shown) in accordance with the first specific voltage signal. The second multiplex output module 460 has a plurality of second output terminals O1˜On and a second input terminal I, wherein the plurality of second output terminals O1˜On are respectively coupled to the plurality of signal output terminals S1˜Sn, the second input terminal I receives the first specific driving signal, and the second multiplex output module 460 outputs the first specific driving signal via a first specific output terminal (such as O1) from the plurality of second output terminals O1˜On to a first specific signal output terminal (such as S1). The switch module 470 is coupled between the DAC 430 and the plurality of signal output terminals S1˜Sn, and is utilized for outputting the first specific voltage signal to the first specific signal output terminal during a second time period different from the first time period. In the meantime, the first multiplex output module 440 will select a second specific voltage signal (such as A2) different from the first specific voltage signal from the plurality of voltage signals A1˜An during the second time period and outputting the second specific voltage signal via the first output terminal O, and the output buffer 450 will generate a second specific driving signal (not shown) in accordance with the second specific voltage signal to the second input terminal I of the second multiplex output module 460 during the second time period; and the second multiplex output module 460 will output the second specific driving signal via a second specific output terminal (such as O2) different from the first specific output terminal from the plurality of second output terminals O1˜On to a second specific signal output terminal (such as S2).

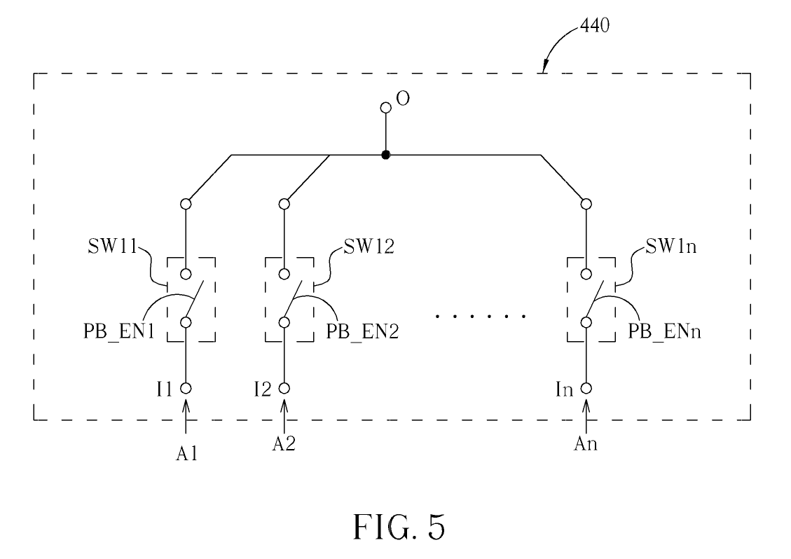

Please refer to FIG. 5. FIG. 5 shows a simplified block diagram of the first multiplex output module 440 in FIG. 4. As shown in FIG. 5, the first multiplex output module 440 comprises a plurality of switch elements SW11˜SW1n, respectively coupled between the plurality of first input terminals I1˜In and the first output terminal O, wherein the plurality of switch elements SW11˜SW1n are controlled by switch control signals PB_EN1˜PB_ENn, respectively.

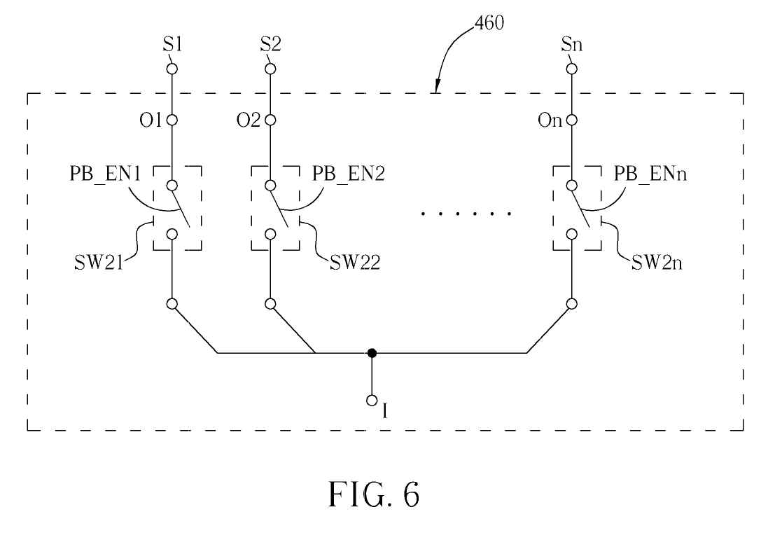

Please refer to FIG. 6. FIG. 6 shows a simplified block diagram of the second multiplex output module 460 in FIG. 4. As shown in FIG. 6, the second multiplex output module 460 comprises a plurality of switch elements SW21˜SW2n, respectively coupled between the plurality of second output terminals O1˜In and the second input terminal I, wherein the plurality of switch elements SW21˜SW2n are controlled by switch control signals PB_EN1˜PB_ENn, respectively.

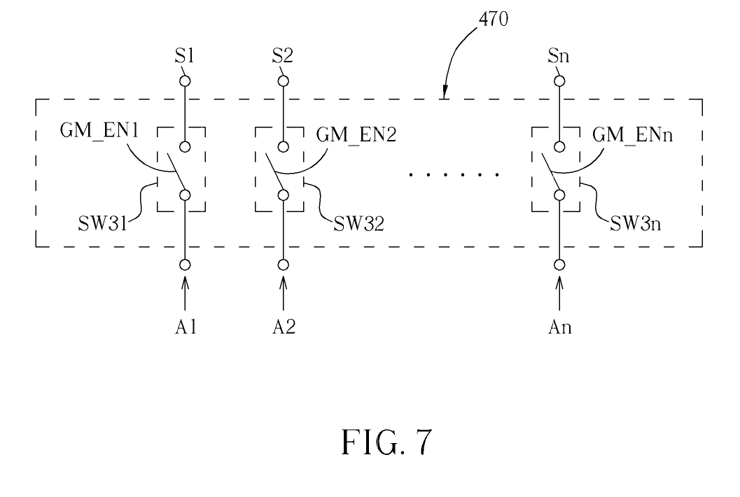

Please refer to FIG. 7. FIG. 7 shows a simplified block diagram of the switch module 470 in FIG. 4. As shown in FIG. 7, the switch module 470 comprises a plurality of switch elements SW31˜SW3n, respectively coupled between the plurality of voltage signals A1˜An and the plurality of signal output terminals S1˜Sn, wherein the plurality of switch elements SW31˜SW3n are controlled by switch control signals GM_EN1˜GM_ENn, respectively.

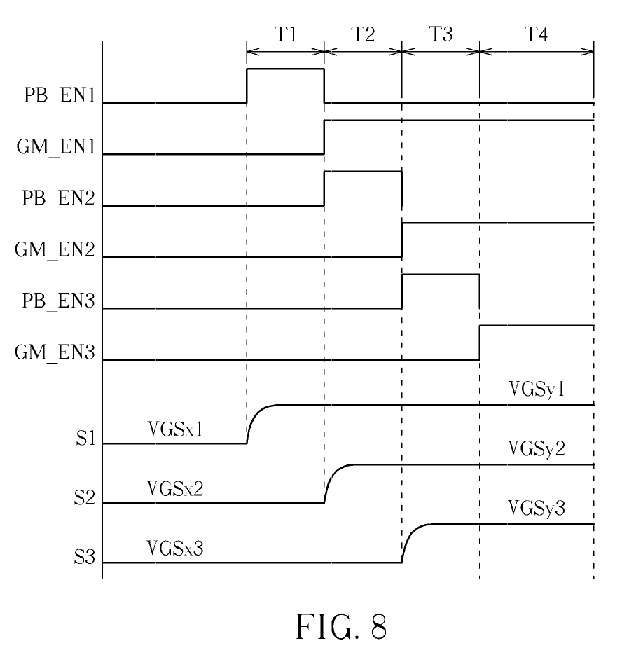

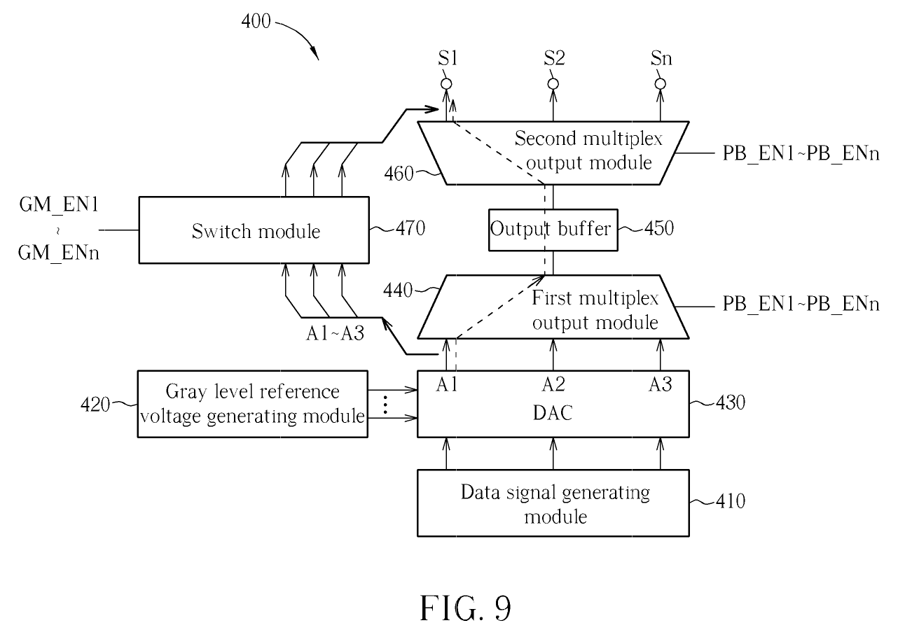

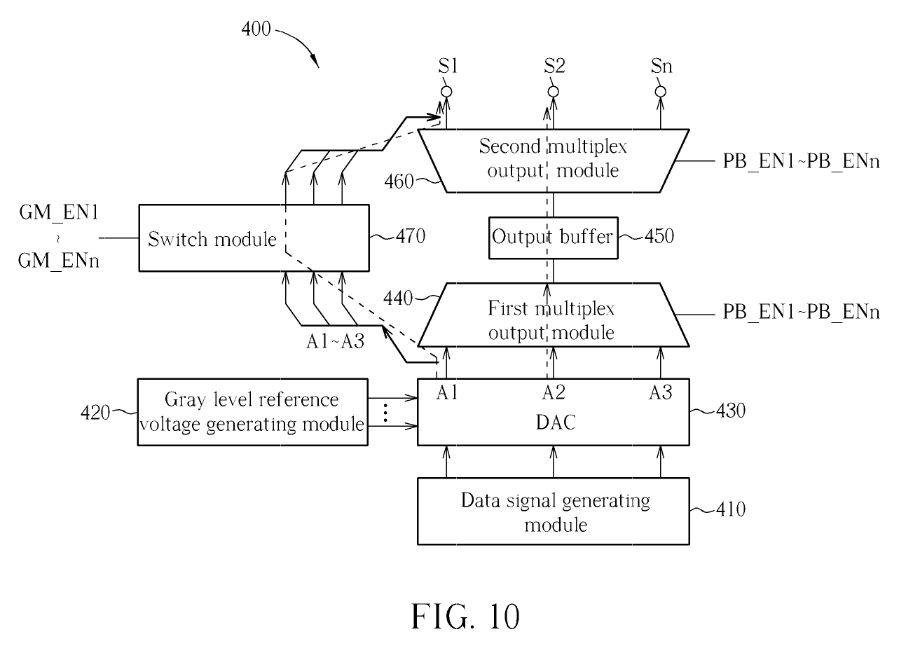

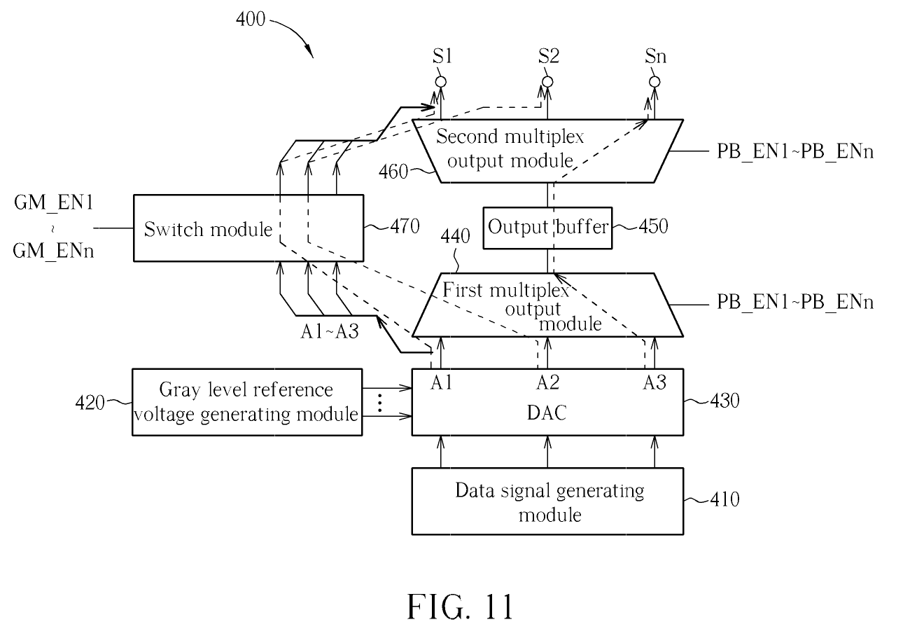

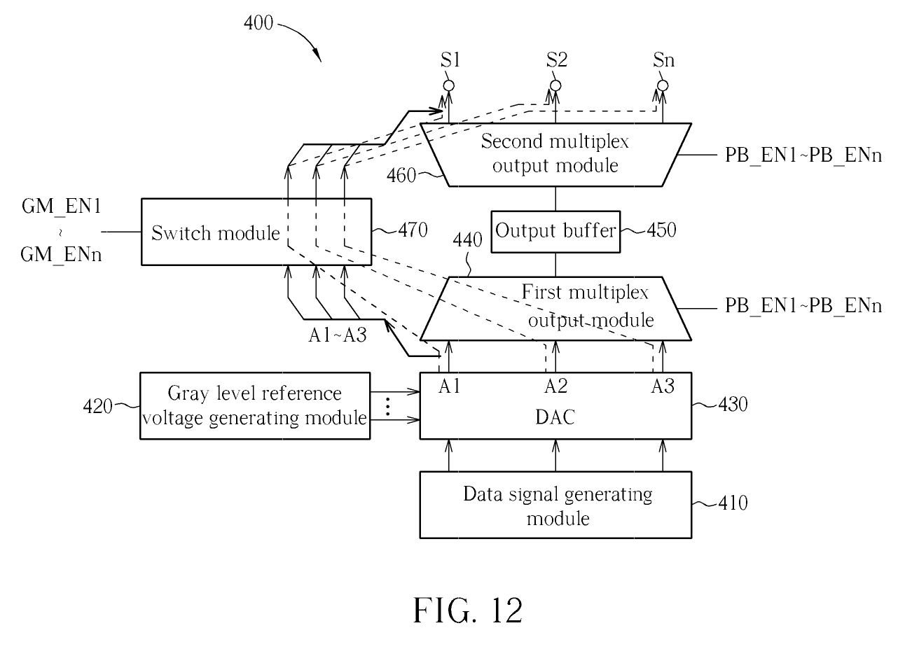

For example, when n=3, Please refer to FIG. 8, FIG. 9, FIG. 10, FIG. 11, and FIG. 12 together. FIG. 8 shows a timing diagram of three switch control signals PB_EN1˜PB_EN3 and three switch control signals GM_EN1˜GM_EN3 and a voltage level variation diagram of three signal output terminals S1˜S3 during the four time periods T1˜T4. FIG. 9 shows a simplified block diagram of the source driver 400 during the time period T1. FIG. 10 shows a simplified block diagram of the source driver 400 during the time period T2. FIG. 11 shows a simplified block diagram of the source driver 400 during the time period T3. FIG. 12 shows a simplified block diagram of the source driver 400 during the time period T4.

In this embodiment, the three switch elements SW11˜SW13, the three switch elements SW21˜SW23, and the three switch elements SW31˜SW33 all are N-type FETs (such as NMOSFETs). Thus, as shown in FIG. 8 and FIG. 9, during the time period T1, the switch control signal PB_EN1 is in a high logic level to conduct the switch element SW11 and the switch element SW21, and the other switch control signal PB_EN2, switch control signal PB_EN3, and the switch control signals GM_EN1 GM_EN3 are in a low logic level to not conduct the switch element SW12, the switch element SW13, the switch element SW22, the switch element SW23, and the switch elements SW31˜SW33. In this way, the voltage signal A1 can pull up the voltage level of the signal output terminal S1 from VGSx1 to near VGSy1 via the output buffer 450.

Next, as shown in FIG. 8 and FIG. 10, during the time period T2, the switch control signal PB_EN1 becomes to be in the low logic level to not conduct the switch element SW11 and the switch element SW21, and the switch control signal PB_EN2 and the switch control signal GM_EN1 become to be in the high logic level to conduct the switch element SW12, the switch element SW22, and the switch element SW31, and the other switch control signal PB_EN3, the switch control signal GM_EN2, and the switch control signal GM_EN3 are in the low logic level to not conduct the switch element SW13, the switch element SW23, and the switch elements SW32˜SW33. In this way, the voltage signal A2 can pull up the voltage level of the signal output terminal S2 from VGSx2 to near VGSy2 via the output buffer 450, and the voltage level of the signal output terminal S1 can be directly calibrated by the voltage signal A1 (i.e. a gray level reference voltage) to be VGSy1.

Next, as shown in FIG. 8 and FIG. 12, during the time period T4, the switch control signal PB_EN1 maintains to be in the low logic level to not conduct the switch element SW11 and the switch element SW21, and the switch control signal GM_EN1 maintains to be in the high logic level to conduct the switch element SW31, and the switch control signal PB_EN2 maintains to be in the low logic level to not conduct the switch element SW12 and the switch element SW22, and the switch control signal GM_EN2 maintain to be in the high logic level to conduct the switch element SW32, and the switch control signal PB_EN3 becomes to be in the low logic level to not conduct the switch element SW13 and the switch element SW23, and the switch control signal GM_EN3 becomes to be in the high logic level to conduct the switch element SW33. In this way, the voltage level of the signal output terminal S3 can be directly calibrated by the voltage signal A3 (i.e. a gray level reference voltage) to be VGSy3, and the voltage level of the signal output terminal S1 can be maintained by the voltage signal A1 to be VGSy1, and the voltage level of the signal output terminal S2 can be maintained by the voltage signal A2 to be VGSy2. In addition, please note that the above embodiment is only for an illustrative purpose and is not meant to be a limitation of the present invention. For example, n can be equal to an arbitrary positive integer.

Briefly summarized, the source driver disclosed by the present invention is capable of reducing the amount of required output buffers, so as to reduce area of the driving circuit efficiently and lower the production cost.

Those skilled in the art will readily observe that numerous modifications and alterations of the device and method may be made while retaining the teachings of the invention.

What is claimed is:

1. A driving circuit, comprising:
a plurality of signal output terminals;
a data signal generating module, for generating a plurality of digital data signals;
a gray level reference voltage generating module, for generating a plurality of gray level reference voltages;
a digital-to-analog converter (DAC), coupled to the data signal generating module and the gray level reference voltage generating module, for generating a plurality of voltage signals corresponding to the plurality of digital data signals in accordance with the plurality of gray level reference voltages, respectively;
a first multiplex output module, having a first output terminal and a plurality of first input terminals, the plurality of first input terminals respectively receiving the plurality of voltage signals, and the first multiplex output module selecting a first specific voltage signal from the plurality of voltage signals during a first time period and outputting the first specific voltage signal via the first output terminal;
an output buffer, coupled to the first output terminal, for generating a first specific driving signal in accordance with the first specific voltage signal;
a second multiplex output module, having a plurality of second output terminals and a second input terminal, the plurality of second output terminals respectively coupled to the plurality of signal output terminals, the second input terminal receiving the first specific driving signal, and the second multiplex output module outputting the first specific driving signal via a first specific output terminal from the plurality of second output terminals to a first specific signal output terminal; and
a switch module, coupled between the DAC and the plurality of signal output terminals, for outputting the first specific voltage signal to the first specific signal output terminal during a second time period different from the first time period.

2. The driving circuit of claim 1, wherein the first multiplex output module selects a second specific voltage signal different from the first specific voltage signal from the plurality of voltage signals during the second time period and outputting the second specific voltage signal via the first output terminal; the output buffer generates a second specific driving signal in accordance with the second specific voltage signal to the second input terminal of the second multiplex output module during the second time period; and the second multiplex output module outputs the second specific driving signal via a second specific output terminal different from the first specific output terminal from the plurality of second output terminals to a second specific signal output terminal.

3. The driving circuit of claim 1, applied to a source driver applied to an LCD panel.

4. The driving circuit of claim 1, wherein the plurality of signal output terminals comprise at least a first signal output terminal and a second signal output terminal; the data signal generating module is utilized for generating at least a first digital data signal and a second digital data signal; the DAC comprises at least a first analog output terminal and a second analog output terminal, respectively for outputting a first voltage signal and a second voltage signal; the switch module comprises at least a first switch element coupled between the first analog output terminal and the first signal output terminal, and a second switch element coupled between the second analog output terminal and the second signal output terminal; the first multiplex output module comprises at least a third switch element coupled between the first analog output terminal and the first output terminal, and a fourth switch element coupled between the second analog output terminal and the first output terminal; and the second multiplex output module comprises at least a fifth switch element coupled between the second input terminal and the first signal output terminal, and a sixth switch element coupled between the second input terminal and the second signal output terminal.

5. The driving circuit of claim 4, wherein during the first time period, the third switch element of the first multiplex output module and the fifth switch element of the second multiplex output module are conducting, and the first switch element and the second switch element of the switch module, the fourth switch element of the first multiplex output module and the sixth switch element of the second multiplex output module are not conducting; and during the second time period, the third switch element of the first multiplex output module and the fifth switch element of the second multiplex output module are not conducting, and the first switch element and the second switch element of the switch module, the fourth switch element of the first multiplex output module and the sixth switch element of the second multiplex output module are conducting.
